(19) United States
(12) Patent Application Publication
(10) Pub. No.: US 2023/0234399 A1
(43) Pub. Date: Jul. 27, 2023

(54) PNEUMATIC VEHICLE TIRE FOR UTILITY VEHICLES

(71) Applicant: Continental Reifen Deutschland GmbH, Hannover (DE)

(72) Inventors: Tiago Moura, Hannover (DE); Florian Berger, Hannover (DE); Fabian Wachmann, Hannover (DE)

(73) Assignee: Continental Reifen Deutschland GmbH, Hannover (US)

(21) Appl. No.: 18/001,467

(22) PCT Filed: Jun. 9, 2021
(86) PCT No.: PCT/DE2021/200079

§ 371 Date: Dec. 10, 2022

(30) Foreign Application Priority Data
Jun. 10, 2020 (DE) 10 2020 207 242.6

(51) Int. Cl. B60C 9/20; B60C 9/00; D07B 1/06

(52) U.S. Cl. CPC B60C 9/2006; B60C 9/0007; D07B 1/0613; D07B 1/062; B60C 2200/06; B60C 2009/0092; B60C 2009/2285

(57) ABSTRACT

The invention relates to a pneumatic utility vehicle tire of a radial type of construction, in particular for trucks, buses, and truck trailers, which has a four-ply or multi-ply belt (4) comprising a barrier ply (5), two working plies (6, 8) and a 0° ply (7), wherein steel cords (10) are arranged in the 0° ply (7), comprising at least two strands (11) each with at least 6 steel filaments (12), and wherein twisting causes each strand to have an identical first twist angle α and the steel cord to have a second twist angle β.

The invention is distinguished in that the steel cord (10) of the 0° ply (7) has the construction 2 to 4×n×d, with n=6 to 8 and with d=0.15 mm to 0.29 mm, wherein this construction means that the steel cord (10) has 2 to 4 twisted-together strands (11), wherein each strand (10) contains 6 to 8 steel filaments (12), in that each steel filament (12) of the steel cord (10) has the same filament diameter (13) and in that the sum of the twist angle α of a strand (11) and the twist angle β of the steel cord lies between 37° and 50°, preferably between 37° and 45°, particularly preferably between 38.5° and 42.5° and most particularly preferably between 39.3° and 41.3°.

The invention relates to a pneumatic vehicle tire for utility vehicles of a radial type of construction, in particular for trucks, buses, and truck trailers, which has a four-ply or multi-ply belt comprising a barrier ply, two working plies and a 0° ply, wherein steel cords are arranged in the 0° ply, comprising at least two strands each with at least 6 steel filaments, and wherein twisting causes each strand to have an identical first twist angle α and the steel cord to have a second twist angle β.

Steel cords for reinforcement plies of vehicle tires are well known to a person skilled in the art. A steel cord is generally distinguished by the fact that it has at least two steel filaments that are twisted together.

Belt constructions of utility vehicle tires are likewise well known to a person skilled in the art. Common belt constructions of utility vehicle tires without a 0° ply commonly have four belt plies, which are composed of steel cords embedded in rubber compounds. The belt plies are commonly numbered consecutively from radially on the inside to radially on the outside. In a 4-ply belt, the radially innermost ply is designated the “1st belt ply” or, depending on its function, the “barrier ply”. Arranged radially on the outside of the latter are the 2nd belt ply and the 3rd belt ply, acting as what are referred to as “working plies”. The radially outer working ply is covered by the 4th belt ply, the “cover ply” or “protective ply”, which is optional.

It is likewise known to provide a further belt ply known as a “0° ply”, the strength members of which run approximately in a circumferential direction of the tire (+/−5° in relation to the circumferential direction) and which is commonly arranged either between the working plies or between the barrier ply of the first working ply. This design results in greater circumferential rigidity, which reduces the mobility of the belt edges and has a positive effect on durability.

The steel cords of the barrier ply generally exhibit an angle of >45° with respect to the circumferential direction and “block” the mobility of the working plies in a lateral direction. The steel cords of the two working plies typically exhibit an identical angle of between 10° and 45° with respect to the circumferential direction of the tire, wherein the steel cords of one working ply are inclined in the opposite direction to the steel cords of the other working ply with respect to the circumferential direction of the tire. Thus, the steel cords of one working ply are arranged so as to cross the steel cords of the other working ply. The working plies are subjected to high shear and tensile forces, bear the main load in the belt and are therefore of particular significance for the belt durability.

The radially outermost belt ply has the function of a protective ply for the two working plies located therebeneath, in that it represents a barrier for stones or other objects that could penetrate the tread assembly. The strength members commonly have an angle of between 15° and 30° in relation to the circumferential direction of the tire. The protective ply protects the working plies against incisions from the outside and, in particular, also against corrosion. This increases the durability and retread capacity of the tire.

It is known to use steel cords of the construction 3×7×0.22 mm in the 0° ply, for example. In this construction, three strands with in each case 7 steel filaments of 0.22 mm diameter are twisted together to form a steel cord. The 7 steel filaments are arranged in each strand such that 6 ply filaments are twisted around 1 core filament. An analogous designation of the construction is 3×(1+6)×0.22 mm.

Such a cord is particularly compact and stable and is nowadays already used in a 0° ply or in the protective ply of utility vehicle tires. The filaments of a strand are arranged close together such that said strand is referred to as “closed” and no rubber can penetrate between the filaments of the cord. For the utility vehicle tire in operation in a 0° ply, in which the strength members are arranged approximately in a circumferential direction, this compactness, and certain elongation that can be achieved only with great expenditure of force, is advantageous in order to maintain the tire contour against the centrifugal forces and the internal pressure.

It is desired to improve the fatigue resistance of the cord in the 0° ply.

The invention therefore addresses the problem of designing a utility vehicle tire comprising a steel cord for a 0° belt ply of the type mentioned at the beginning in such a way that it has improved durability.

The object is achieved according to the invention in that the steel cord of the 0° ply has the construction 2 to 4×n×d, with n=6 to 8 and with d=0.15 mm to 0.29 mm, wherein this construction means that the steel cord has 2 to 4 twisted-together strands, wherein each strand contains 6 to 8 steel filaments, in that each steel filament of the steel cord has the same filament diameter and in that the sum of the twist angle α of a strand and the twist angle β of the steel cord lies between 37° and 50°, preferably between 37° and 45°, particularly preferably between 38.5° and 42.5° and most particularly preferably between 39.3° and 41.3°.

Surprisingly, it has been shown that steel cords of the aforementioned construction and with a sum of the twist angle α of a strand and the twist angle β of the cord of between 37° and 50° are particularly fatigue-resistant and therefore have improved durability.

This advantage has been shown in particular when the sum of the twist angle α of a strand and the twist angle β of the cord is between 37° and 45°, preferably between 38.5° and 42.5° and particularly preferably between 39.3° and 41.3°.

The twist angle α of a strand is calculated using the following formula:

$$α = arctan ( \frac{2 π \cdot d}{{L}_{s}} )$$

where:
Ls: lay length of the strand, which is the axial distance required for a 360° rotation of a steel filament about the longitudinal axis of the strand
d: diameter of each filament.

The twist angle β of the cord is calculated using the following formula:

$$β = arctan ( \frac{3 π \cdot d}{{L}_{c} \cdot sin ( \frac{π}{m} )} )$$

where
Lc: lay length of the cord, which is the axial distance required for a 360° rotation of a strand about the longitudinal axis of the cord
d: diameter of each filament
m: number of strands in the cord.

Each twist angle α commonly has a manufacturing tolerance of up to +/−0.5°.

It is advantageous if the cord has the construction 3×7×d, with d=0.20 mm to 0.24 mm, particularly preferably the construction 3×7×0.22 mm, and if the sum of the twist angle α of a strand and the twist angle β of the cord lies in a range from 39.3° to 41.3°, preferably amounts to 40.3°, with each strand having a twist angle α in a range from 19° to 20°, preferably 19.5°, and the cord having a twist angle β in a range from 20.3° to 21.3°, preferably 20.8°.

The table below shows a preferred exemplary embodiment of a steel cord for the 0° ply of a pneumatic vehicle tire according to the invention compared to a steel cord of the 3×7×0.22 construction for the 0° ply of a prior art pneumatic vehicle tire.

TABLE

| | | Steel cord for the 0° |
|---|---|---|
| | Steel cord for the 0° | ply of a pneumatic |
| | ply of a prior art | vehicle tire according |
| Parameter | pneumatic vehicle tire | to the invention |
| Steel cord construction | 3 × 7 × 0.22 | 3 × 7 × 0.22 |
| Strand lay length (mm) | 4.8 | 3.9 |
| Steel cord lay length | 8 | 6.3 |
| (mm) | | |
| Twist angle α of the | 16.1 | 19.5 |
| strand (degrees) | | |
| Twist angle β of the | 16.7 | 20.8 |
| cord (degrees) | | |
| Sum of the twist | 32.7 | 40.3 |
| angle α and the twist | | |
| angle β (degrees) | | |
| Lay direction of rod | S | S |
| Lay direction of cord | S | S |

In one embodiment of the pneumatic vehicle tire for utility vehicles with a 4-ply belt, wherein a barrier ply, and a first and a second working ply are arranged in a sequence from radially on the inside to radially on the outside, it is expedient if the 0° ply is arranged either between the barrier ply and the first working ply or preferably between the first working ply and the second working ply.

In another embodiment of the pneumatic vehicle tire for utility vehicles with a 5-ply belt, wherein a barrier ply, a first and a second working ply, and a protective ply are arranged in a sequence from radially on the inside to radially on the outside, it is expedient if the 0° ply is arranged either between the barrier ply and the first working ply or preferably between the first working ply and the second working ply.

Further features, advantages and details of the invention will now be described in more detail on the basis of the schematic drawings, which illustrate an exemplary embodiment. In the drawings:

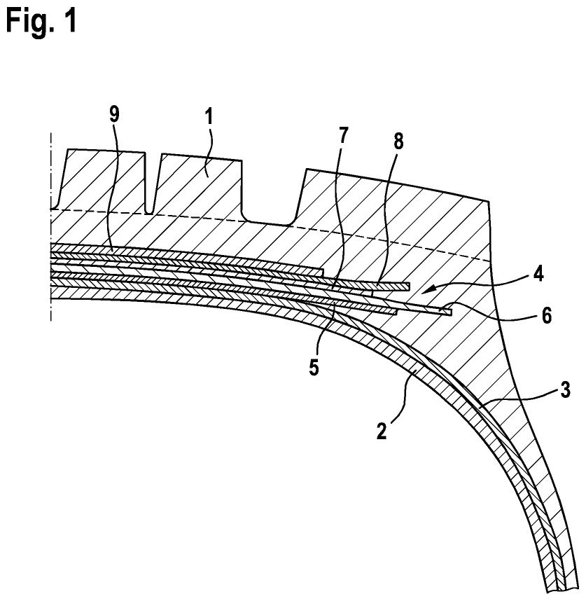

FIG. 1 shows a partial cross section through a pneumatic utility vehicle tire according to the invention in the region of the belt and tread;

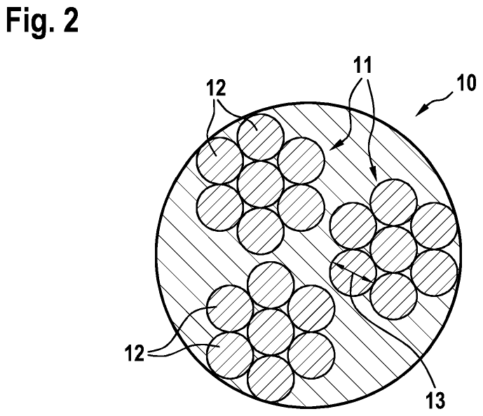

FIG. 2 shows a cross section through a strength member which is arranged in the 0° ply of the utility vehicle tire of FIG. 1.

FIG. 1 shows a cross section through the region of the tread and belt of a pneumatic vehicle tire according to the invention for utility vehicles, for example trucks, buses or truck trailers. Of the components that are commonly present in the illustrated region of the pneumatic vehicle tire, a profiled tread 1, an inner ply 2, a carcass insert 3 and a multi-ply belt 4 are shown. The belt padding and the like that is commonly provided between the edge portions of the belt plies, in particular in the region of the belt ply edges, is not shown.

The belt 4 has five belt plies 5, 6, 7, 8 and 9, wherein the first belt ply is the radially innermost belt ply 5 and is configured as a barrier ply. The second belt ply 6 is a working ply, followed by the 3rd belt ply, which is designed as a 0° ply 7, above which the fourth belt ply 8 is arranged as a working ply. The fourth belt ply 8 is adjoined by the radially outermost belt ply 9, the protective ply. All belt plies 5, 6, 7, 8 and 9 are composed of strength members embedded in a rubber compound, the so-called belt rubber coating, which strength members run parallel to one another in each ply.

The strength members in the belt plies 5, 6, 7, 8 and 9 are inclined at particular angles relative to the circumferential direction. Proceeding from the radially innermost belt ply 5, the strength members run in accordance with the sequence right-hand pitch—right-hand pitch—0°—left-hand pitch—left-hand pitch. A 0° belt ply 7 is to be understood to mean a belt ply in which the strength members run in a circumferential direction, and deviate by at most ±5° from the exact 0° orientation (=tire circumferential direction). The angle of the strength members in the first belt ply 5 is 45° to 90°, in particular 48° to 57°, the angle of the strength members in the 0° belt ply 7 is 0°±5°, the angles of the strength members in the second and third belt plies (working plies) 6, 8 are in each case 10° to 45°, and the angle of the strength members in the fourth belt ply 9 is likewise 10° to 45°, in each case in relation to the circumferential direction. As already mentioned, the second belt ply 6 and the third belt ply 8 are working plies, and the strength members thereof therefore run at relatively small angles with respect to the circumferential direction, and the plies have oppositely directed pitches.

The strength member 10 of FIG. 2 is arranged in the 0° belt ply 7 of the belt region of the utility vehicle tire of FIG. 1. The construction is 3×7×0.22 mm, which means that this steel cord 10 has three twisted-together strands 11, each strand 11 containing seven steel filaments 12. The steel filaments 12 are arranged in each strand 11 in such a way that one steel filament 12 is arranged as the core filament and the 6 other steel filaments 12 are arranged in a first ply around said core filament. Another way of writing the construction is 3×(1+6)×0.22 mm. Each steel filament 12 of the steel cord 10 has the same filament diameter 13 of 0.22 mm. Each strand 11 is twisted with the same twist angle α, with α=19.5°, and the steel cord 10 is twisted with a twist angle β, with β=20.8°. The sum of the twist angle α and the twist angle β is between 39.3° and 41.3° and amounts to 40.3° here. The twist angle α is smaller than the twist angle β. Each strand 11 and the steel cord 10 are twisted in the same direction, that is, each strand 11 and the steel cord 10 are twisted in the S or Z direction.

### LIST OF REFERENCE SIGNS

1 . . . Tread
2 . . . Inner ply
3 . . . Carcass insert
4 . . . Belt
5 . . . Barrier ply
6 . . . Working ply
7 . . . 0° belt ply
8 . . . Working ply
9 . . . Protective ply
10 . . . Steel cord
11 . . . Strand
12 . . . Steel filament
13 . . . Diameter of the steel filament (d)

1.-6. (canceled)

7. A pneumatic vehicle tire for utility vehicles, the tire comprising:
a radial type of construction having a multi-ply belt (4) comprising a barrier ply (5), two working plies (6, 8) and a 0° ply (7), wherein steel cords (10) are arranged in the 0° ply (7), comprising at least two strands (11) each with at least 6 steel filaments (12), and wherein each strand has an identical first twist angle α and the cord has a second twist angle β,
the steel cord (10) of the 0° ply (7) has the construction 2 to 4×n×d, with n=6 to 8 and with d=0.15 mm to 0.29 mm, the steel cord (10) has 2 to 4 twisted-together strands (11), wherein each strand (10) contains 6 to 8 steel filaments (12), in that each steel filament (12) of the steel cord (10) has the same filament diameter (13) and in that the sum of the twist angle α of a strand (11) and the twist angle β of the steel cord lies between 37° and 50°.

8. The pneumatic vehicle tire as claimed in claim 7, wherein the steel cord (10) has the construction 3×7×d with d=0.20 mm to 0.24 mm, and the sum of the twist angle α of a strand and the twist angle β of the cord lies in a range from 39.3° to 41.3° with each strand having a twist angle α in a range from 19° to 20°, and the cord having a twist angle in a range from 20.3° to 21.3°.

9. The pneumatic vehicle tire (10) as claimed in claim 8, the steel cord (10) has the construction 3×7×d, with d=0.22 mm, and in that the sum of the twist angle α of a strand (11) and the twist angle β of the steel cord (10) is 40.3°, each strand (11) having a twist angle α of 19.5° and the steel cord (10) having a twist angle β of 20.8°.

10. The pneumatic vehicle tire (10) of claim 7, each strand (11) and the steel cord (10) are twisted in the same direction in one of the S or in the Z direction.

11. The pneumatic vehicle tire of claim 7, wherein a barrier ply (5), and a first and a second working ply (6, 8) are arranged in a sequence from radially on the inside to radially on the outside, in that the 0° ply (7) is arranged between the first working ply (6) and the second working ply (8).

12. The pneumatic vehicle tire of claim 7, the multi-ply is a 5-ply belt (4), wherein a barrier ply (5), a first and a second working ply (6, 8), and a protective ply (9) are arranged in a sequence from radially on the inside to radially on the outside, the 0° ply (7) is arranged between the first working ply (6) and the second working ply (8).

13. A pneumatic vehicle tire for utility vehicles, the tire comprising:
a radial type of construction having a four-ply belt (4) comprising a barrier ply (5), a first working ply (6, 8), a second working ply and a 0° ply (7), wherein steel cords (10) are arranged in the 0° ply (7), comprising at least two strands (11) each with at least 6 steel filaments (12), and wherein each strand has an identical first twist angle α and the cord has a second twist angle β;
the steel cord (10) of the 0° ply (7) has the construction 2 to 4×n×d, with n=6 to 8 and with d=0.15 mm to 0.29 mm, the steel cord (10) has 2 to 4 twisted-together strands (11), wherein each strand (10) contains 6 to 8 steel filaments (12), in that each steel filament (12) of the steel cord (10) has the same filament diameter (13) and in that the sum of the twist angle α of a strand (11) and the twist angle θ of the steel cord lies between 39.3° and 41.3° to facilitate fatigue resistance; and
the barrier ply (5), and the first working ply and the second working ply are arranged in a sequence from radially on the inside to radially on the outside, in that the 0° ply (7) is arranged between the first working ply (6) and the second working ply (8).
